(19) United States
(12) Patent Application Publication
(10) Pub. No.: US 2025/0390593 A1
(43) Pub. Date: Dec. 25, 2025

(54) EXECUTING A DATABASE QUERY RESPONSIVE TO A SEARCH QUERY

(71) Applicant: Capital One Services, LLC, McLean, VA (US)

(72) Inventor: Meet PATEL, Frisco, TX (US)

(21) Appl. No.: 18/751,070

(22) Filed: Jun. 21, 2024

(51) Int. Cl. G06F 21/62

(52) U.S. Cl. CPC G06F 21/6218; G06F 2221/2113; G06F 2221/2141

(57) ABSTRACT

In some implementations, a device may receive, from a user device, a request indicating a search query, where the search query is associated with a user. The device may identify, responsive to the request, information indicating a set of data access permissions for the user. The device may identify, responsive to the request and the search query, a database query. The device may cause, provided that the set of data access permissions permits the user to access data associated with execution of the database query, execution of the database query. The device may transmit the data for the user device.

### BACKGROUND

Database queries are used to extract specific information from databases, enabling users to retrieve data tailored to their needs efficiently. Through structured query language (SQL) queries, users can formulate commands to interact with relational databases, specifying criteria for selecting and filtering relevant data. Queries can range from simple requests for individual records to complex operations involving multiple tables and intricate conditions.

### SUMMARY

Some implementations described herein relate to a system for executing a database query responsive to a search query. The system may include one or more memories and one or more processors communicatively coupled to the one or more memories. The one or more processors may be configured to receive, from a user device, a request indicating a search query, where the search query is associated with a user. The one or more processors may be configured to identify, responsive to the request, a set of data access permissions for the user. The one or more processors may be configured to identify, responsive to the request, a search result, for the search query, that includes a database query from a library of database queries that have been previously executed. The one or more processors may be configured to parse the database query to extract, from the database query, data access information that indicates at least one of: one or more databases, one or more database tables, or one or more data fields in the database query. The one or more processors may be configured to determine, based on the data access information, whether the set of data access permissions permits the user to access data associated with execution of the database query. The one or more processors may be configured to transmit, based on the set of data access permissions permitting the user to access the data, the database query to a data system to cause execution of the database query by the data system. The one or more processors may be configured to receive, from the data system, the data. The one or more processors may be configured to transmit the data for the user device.

Some implementations described herein relate to a method of executing a database query responsive to a search query. The method may include receiving, from a user device, a request indicating a search query, where the search query is associated with a user. The method may include identifying, responsive to the request, a set of data access permissions for the user. The method may include identifying, responsive to the request, a search result, for the search query, that includes one or more database queries from a library of database queries that have been previously executed. The method may include analyzing a database query, of the one or more database queries, to identify data access information relating to data associated with execution of the database query. The method may include determining, based on the data access information, whether the set of data access permissions permits the user to access the data. The method may include transmitting, based on the set of data access permissions permitting the user to access the data, the database query to a data system to cause execution of the database query by the data system. The method may include receiving, from the data system, the data. The method may include transmitting the data for the user device.

Some implementations described herein relate to a non-transitory computer-readable medium that stores a set of instructions for executing a database query responsive to a search query. The set of instructions, when executed by one or more processors of a device, may cause the device to receive, from a user device, a request indicating a search query, where the search query is associated with a user. The set of instructions, when executed by one or more processors of the device, may cause the device to identify, responsive to the request, information indicating a set of data access permissions for the user. The set of instructions, when executed by one or more processors of the device, may cause the device to identify, responsive to the request and the search query, a database query. The set of instructions, when executed by one or more processors of the device, may cause the device to cause, provided that the set of data access permissions permits the user to access data associated with execution of the database query, execution of the database query. The set of instructions, when executed by one or more processors of the device, may cause the device to transmit the data for the user device.

### BRIEF DESCRIPTION OF THE DRAWINGS

FIGS. 1A-1F are diagrams of an example associated with executing a database query responsive to a search query, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with executing a database query responsive to a search query, in accordance with some embodiments of the present disclosure.

FIG. 4 is a flowchart of an example process associated with executing a database query responsive to a search query, in accordance with some embodiments of the present disclosure.

### DETAILED DESCRIPTION

The following detailed description of example implementations refers to the accompanying drawings. The same reference numbers in different drawings may identify the same or similar elements.

A device can perform database queries to extract data from one or more databases. Each database may house data across multiple database tables, with each database table containing various data fields. Within these databases, database tables, and data fields, a significant amount of sensitive data may be stored, access to which may be restricted based on user permissions. Consequently, some database queries may inadvertently attempt to access data beyond a user’s authorized scope. Allowing a user to access data beyond their authorized scope compromises data security by potentially exposing sensitive information to unauthorized individuals or entities. Moreover, executing unauthorized database queries consumes valuable computing resources (e.g., processor resources and/or memory resources), diverting these resources away from legitimate tasks and affecting overall system efficiency.

In addition, in some cases, a database query may be constructed manually, which can be time consuming and error prone. Thus, manual database query construction resulting in suboptimal query design may inefficiently utilize computing resources (e.g., processor resources and/or memory resources). Furthermore, manually-constructed database queries may lack optimization, leading to inefficient execution plans that consume excessive computing resources to process data unnecessarily.

Some implementations described herein enable identification of a database query based on a search query that indicates data of interest. In some implementations, using the search query, the database query may be identified from a library of database queries that have been previously executed. The library of database queries may include database queries that have execution properties that satisfy one or more conditions, which can be designed to exclude, from the library, database queries that are not highly efficient. In some other implementations, using the search query, the database query may be generated by a machine learning model. In this way, the database query that is identified/generated may be optimized with an efficient execution plan. Accordingly, execution of the database query may conserve computing resources relative to database queries that lack optimization.

Prior to execution of a database query, the database query can be analyzed (e.g., parsed or deconstructed) to identify data access information relating to the database query. For example, the data access information may indicate one or more databases, database tables, and/or data fields that would be accessed by execution of the database query. The data access information can be compared to a set of permissions for a user associated with the database query to determine whether the set of access permissions permits the user to access the data associated with execution of the database query (e.g., the data that would be retrieved by the database query). Accordingly, the database query can be executed if the set of access permissions permits the user to access the data, or dropped if the set of access permissions does not permit the user to access the data. In this way, data security is maintained at a high level, and computing resources are expended only for legitimate database queries.

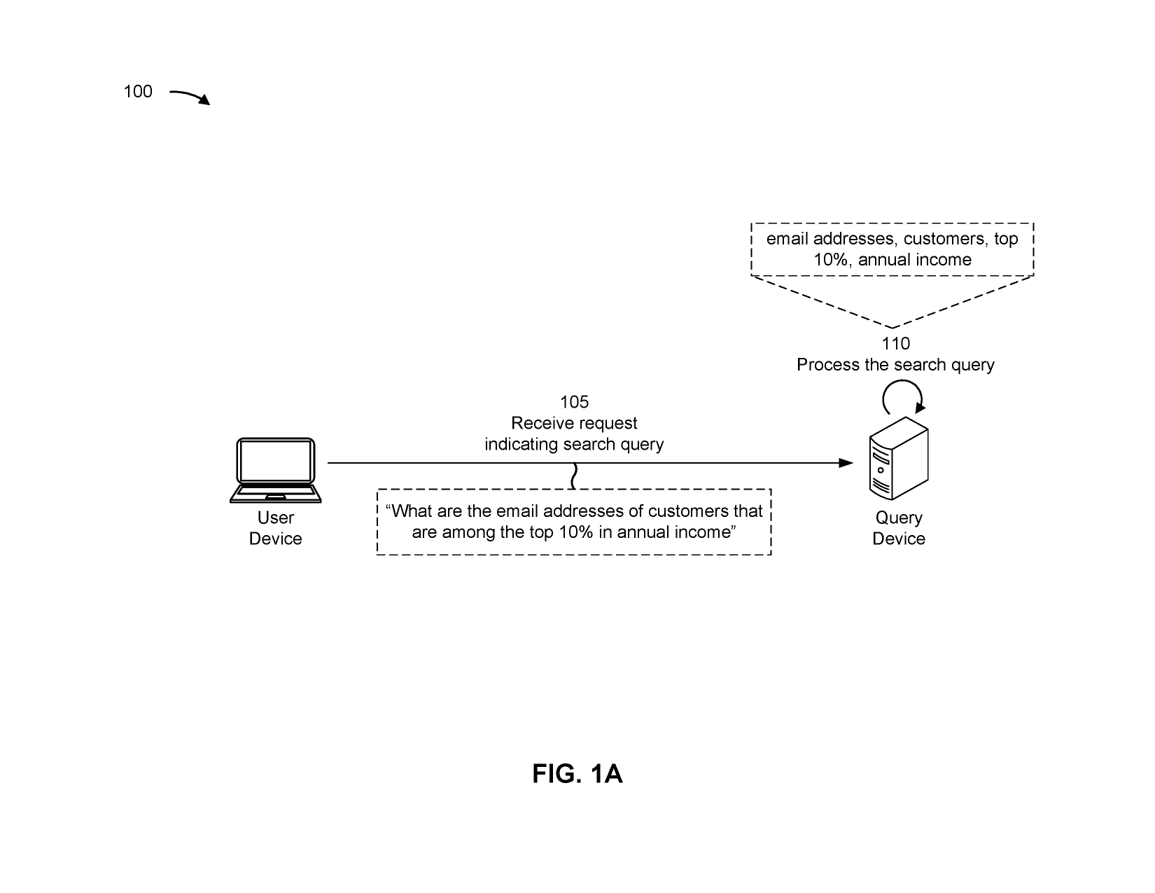

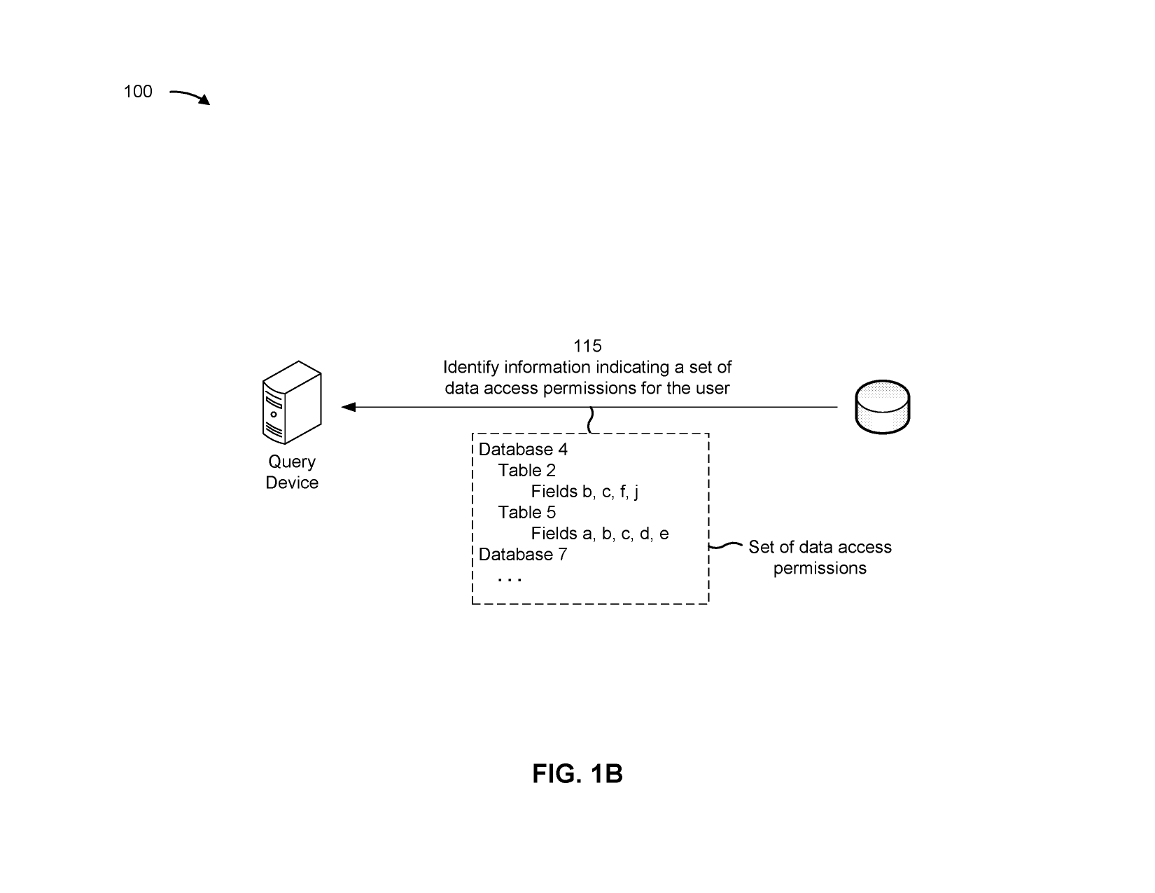

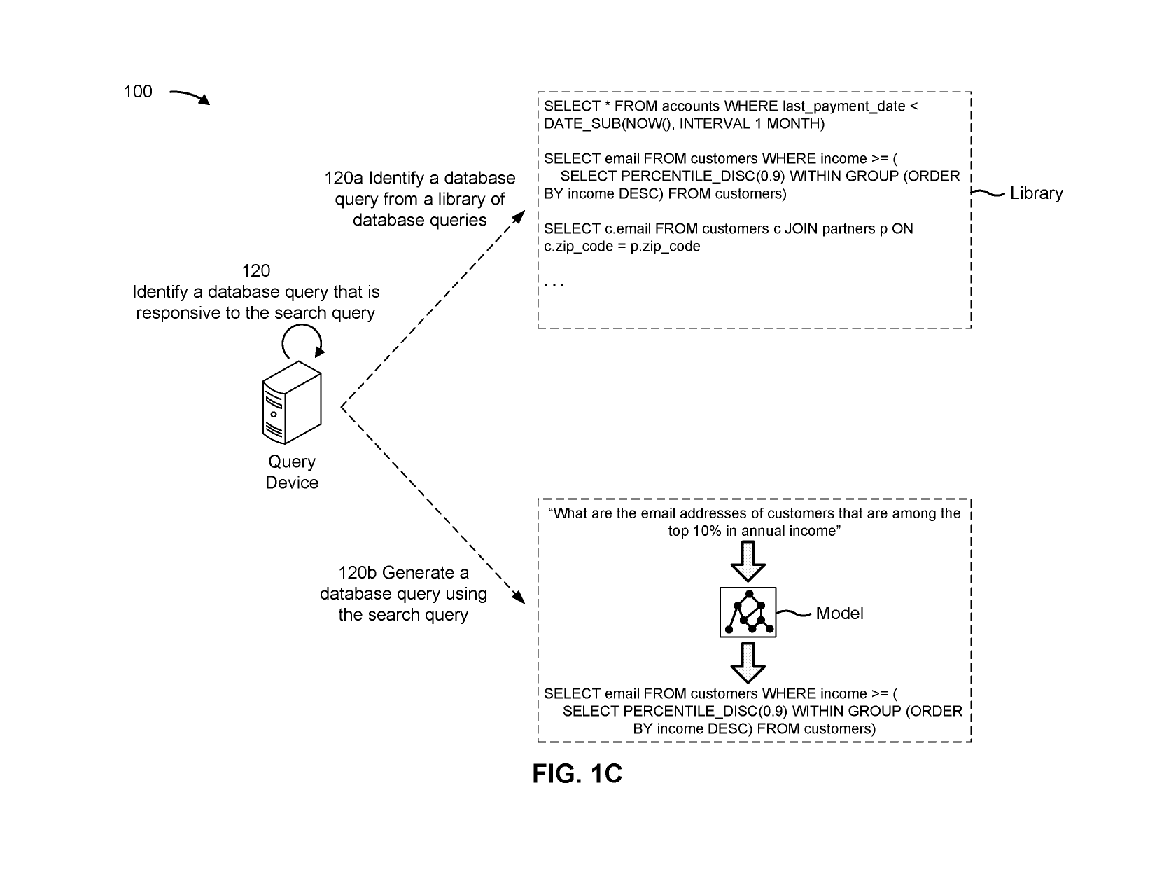

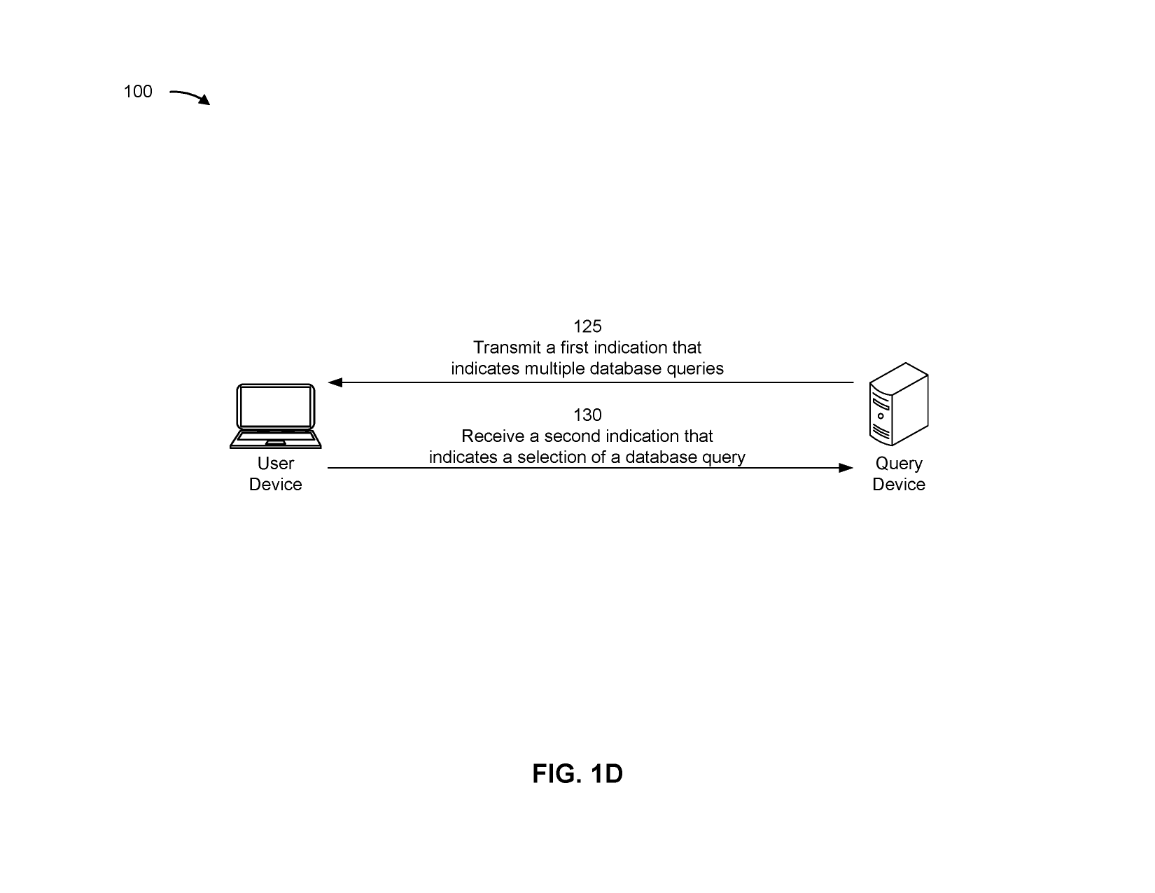

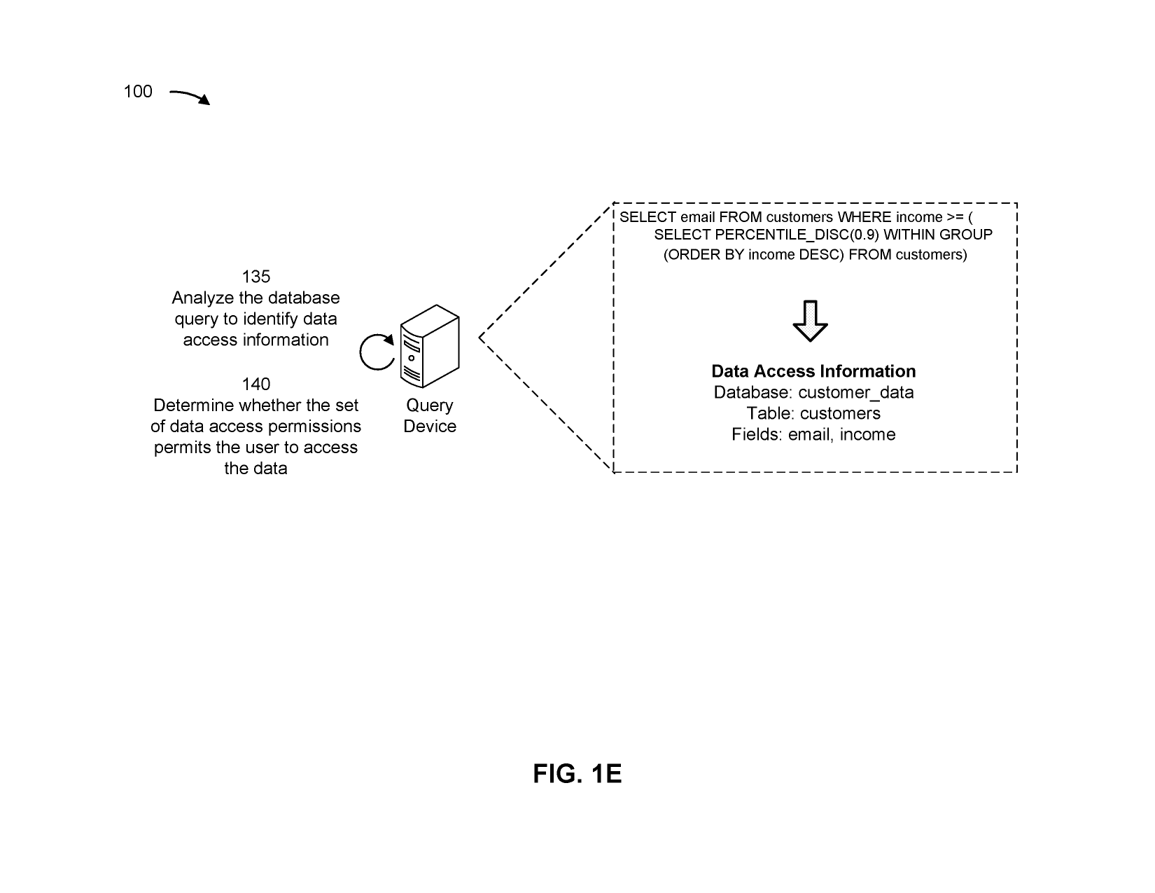

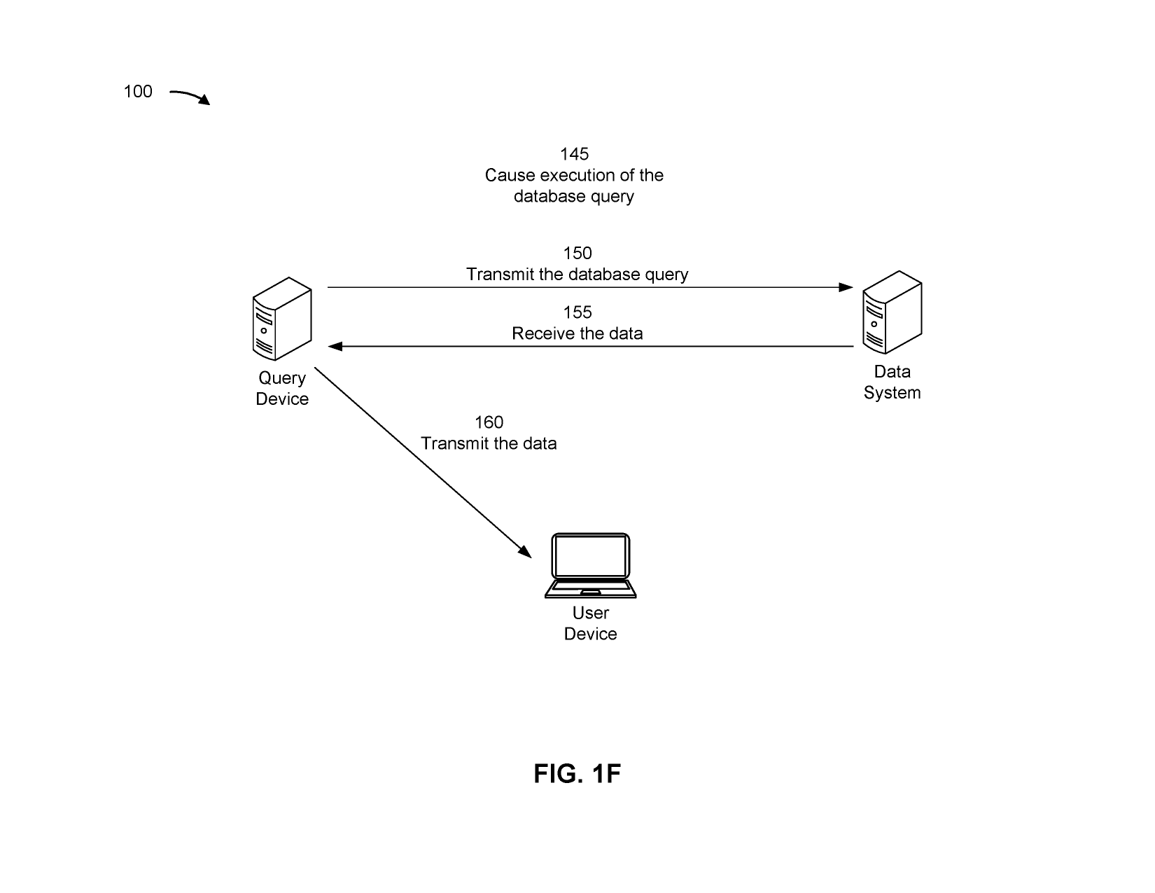

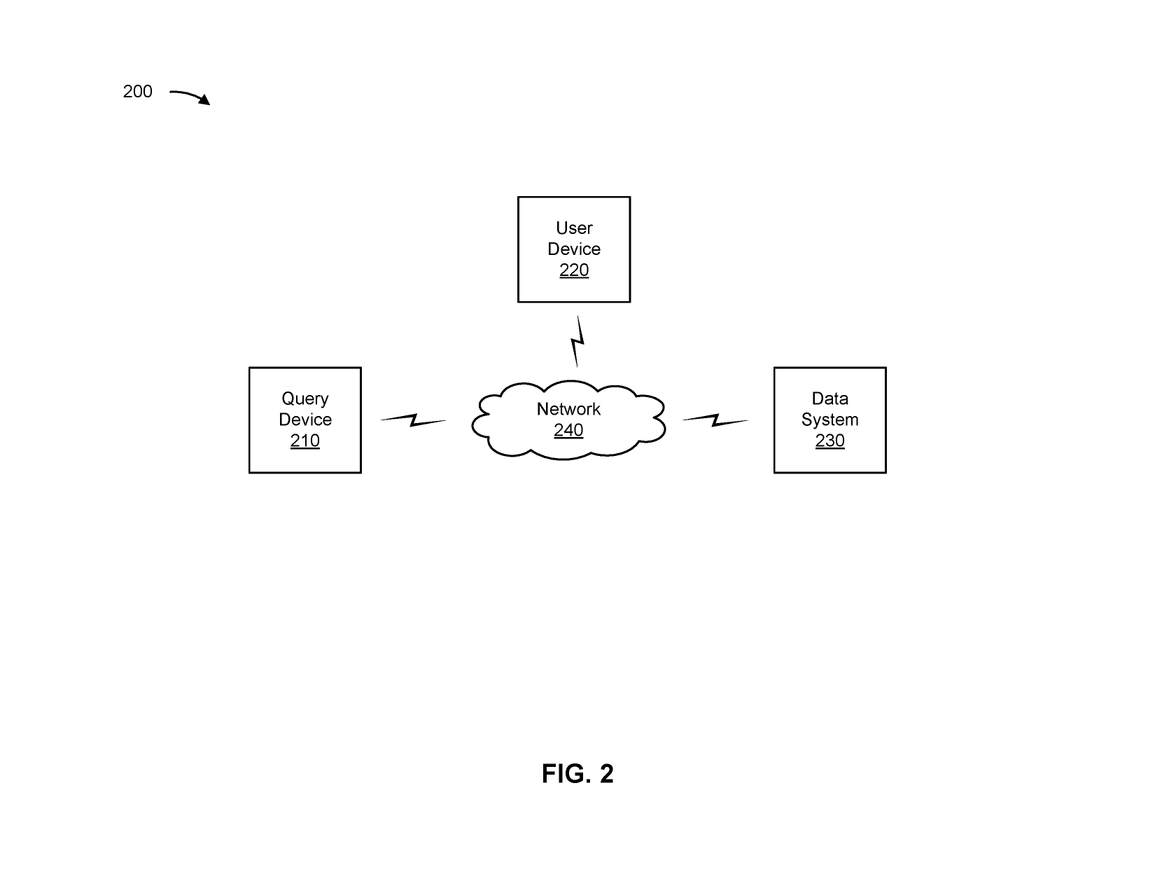

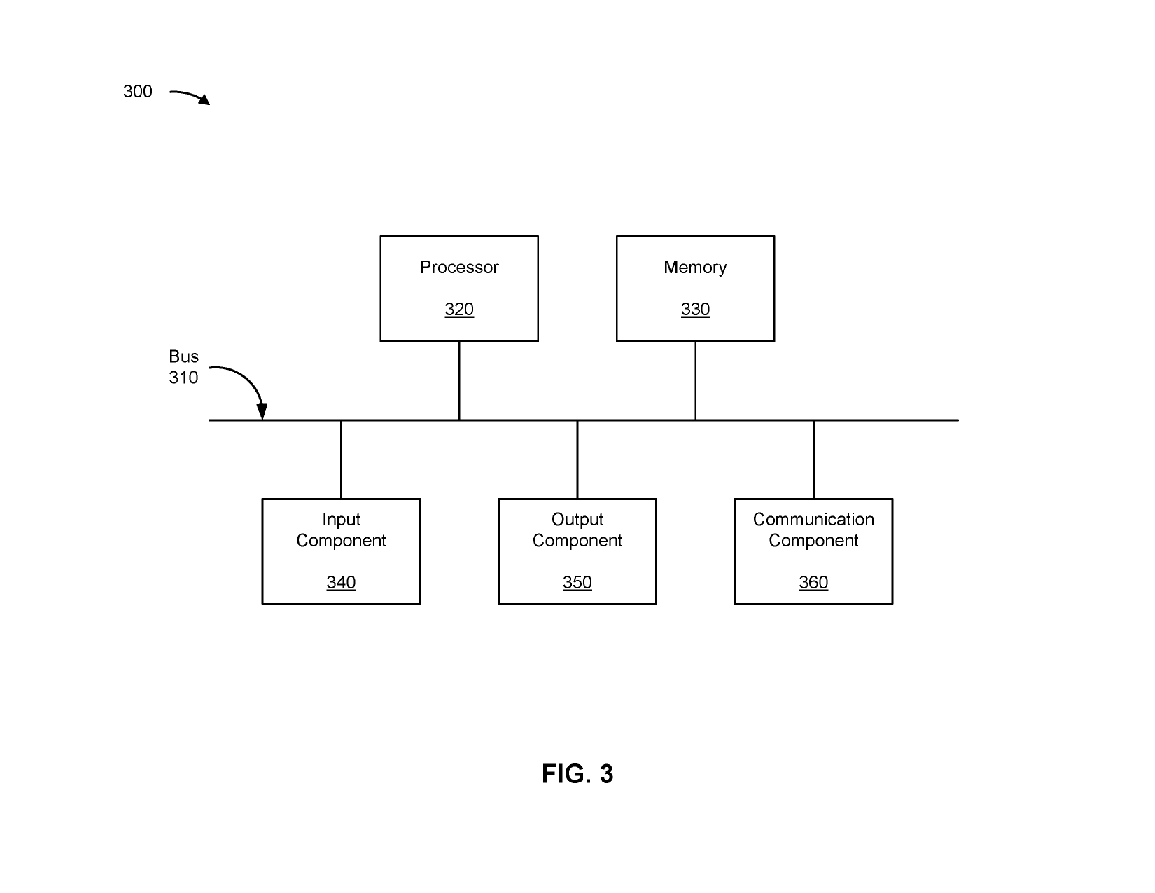

FIGS. 1A-1F are diagrams of an example 100 associated with executing a database query responsive to a search query. As shown in FIGS. 1A-1F, example 100 includes a query device, a user device, and a data system (e.g., one or more data systems). These devices are described in more detail in connection with FIGS. 2 and 3.

The query device may communicate with the data system to execute database queries and retrieve data. For example, the data system may implement one or more databases that store the data. In some implementations, the data system may include or may be included in the query device, or the data system and the query device may be components of a higher-level system. In some implementations, the data system may include a cloud-based data warehouse (or a cloud-based data lake). The data system may implement a data service that facilitates communication between the query device and the data system (e.g., via an application programming interface (API)).

The user device may be used by a user, such as a data analyst or a data engineer, that is tasked with gathering data of interest to an interested party (e.g., an ad hoc data request). In some implementations, the user may be the interested party. The user device may receive a user input, from the user, that includes a search query indicating the data of interest. The search query may include a keyword-based search query (e.g., that uses Boolean operators) or a natural-language search query. For example, a natural-language search query may indicate, “What are the email addresses of customers that are among the top 10% in annual income?”

As shown in FIG. 1A, and by reference number 105, the user device may transmit, and the query device may receive, a request indicating the search query. The request may be a hypertext transfer protocol (HTTP) request. The search query may be associated with the user. For example, the user may have provided the user input indicating the search query, the search query may relate to data of interest to the user, or the like. In some implementations, the request, or a previous indication from the user device to the query device, may indicate a user identifier (user ID) of the user, which may be identified in connection with the user logging into an account, initiating a session, entering the user ID into a form, or the like.

As shown by reference number 110, the query device may process the search query. In some implementations, the query device may process the search query to extract keywords from the search query and/or to derive a meaning of the search query. For example, the query device may process the search query using a keyword extraction algorithm, a natural language processing technique, a semantic analysis technique, or a machine learning model (e.g., a large language model (LLM)), among other examples.

As shown in FIG. 1B, and by reference number 115, responsive to the request, the query device may identify information indicating a set of data access permissions for the user. The query device may identify the information indicating the set of data access permissions using the user ID. For example, the information may be mapped to the user ID or otherwise associated with the user ID. In some implementations, the information indicating the set of data access permissions may include information about the user, that implies the set of data access permissions, or may include the set of data access permissions itself. For example, the information about the user may include an organizational role of the user (e.g., director, vice president, manager, or the like), a department or team that includes the user (e.g., accounting department, engineering department, or the like) and/or a data access level of the user (e.g., level 5 data access, level 2 data access, or the like), among other examples. The set of data access permissions may indicate one or more data sources and/or one or more data types that the user is permitted to access. For example, the set of data access permissions may indicate one or more databases that the user is permitted to access, one or more database tables that the user is permitted to access, one or more data fields (e.g., database table columns) that the user is permitted to access, and/or one or more data categories (e.g., personally-identifiable information, website interaction data, and/or account settings data, among other examples) that the user is permitted to access.

As shown in FIG. 1C, and by reference number 120, responsive to the request, the query device may identify a database query that is responsive to the search query. The database query is a request made to a database system to retrieve, manipulate, or perform operations on data stored in a database (e.g., a relational database). For example, in some contexts described herein, the database query is a request to retrieve data stored in a database. The database query may be an SQL query.

In some implementations, as shown by reference number 120a, the query device may identify the database query from a library of database queries. For example, the query device may identify a search result, for the search query, that includes one or more database queries from the library. The library may include database queries that have been previously constructed and executed for users. In some implementations, the library may include only database queries that have execution properties that satisfy one or more conditions. The execution properties may relate to an execution time, a processor usage, a memory usage, a quantity of disk input/output operations, or the like. In this way, the one or more conditions may restrict the library only to database queries that are highly efficient. In some implementations, users may be incentivized to add database queries to the library through a gamification system that rewards users for adding database queries to the library and/or when users’ database queries are “favorited” by other users. In some implementations, database queries that are not highly rated by users (e.g., the rating is below a threshold, a number of times that the database query has been favorited is below a threshold, or the like) may be dropped from the library. Conversely, database queries that are highly rated by users may be promoted (e.g., may have a higher ranking in a search result).

The query device may identify the search result by searching the library using the search query (e.g., keywords extracted from the search query). For example, the query device may search the text of the database queries themselves and/or may search metadata relating to the database queries. As an example, for a database query, the metadata may include tags associated with the database query, information indicating one or more database tables used by the database query, a natural-language summary of the database query, and/or a natural-language summary of the data that the database query is configured to retrieve, among other examples. In some implementations, the query device may generate the summary of the database query and/or the summary of the data. For example, the query device may generate the summary of the database query and/or the summary of the data using a natural language generation technique or an LLM. Additionally, or alternatively, the query device may generate the summary of the database query and/or the summary of the data using a machine learning model trained to understand the semantics and intent behind a database query coupled with metadata indicating a database schema.

In some implementations, the query device may modify a database query, found in the library, in accordance with the search query. For example, the database query found in the library may be a close match for the search query but not an exact match. In some implementations, the query device may modify the database query using a genetic programming technique. As an example, the query device may generate a set of candidate database queries, that are modified versions of the database query, and evaluate levels of fitness of the candidate database queries for retrieving the data indicated by the search query. The query device may select a most-fit candidate database query, generate a new set of candidate database queries, that are modified versions of the most-fit database query, and evaluate the levels of fitness of those new candidate database queries, and so forth. Accordingly, the query device may iteratively modify the database query in this manner until arriving at a modified database query that has a maximum level of fitness or that the query device determines will retrieve the data indicated by the search query.

In some implementations, as shown by reference number 120b, the query device may generate one or more database queries using the search query. For example, the query device may generate the one or more database queries using the search query (e.g., alone, in combination with other information, or a transformation thereof) as an input to a machine learning model. The machine learning model may be trained on a training set that indicates historical search queries and the corresponding historical search results (that indicate database queries) returned for the historical search queries. The machine learning model may be trained to output one or more database queries based on an input that describes data of interest. The machine learning model may include a transformer model, a sequence-to-sequence model, a graph neural network model, a deep learning model, or the like.

In some implementations, where the query device has identified multiple database queries, the query device may select a closest matching database query for the search query, or may present the multiple database queries for selection by the user. For example, as shown in FIG. 1D, and by reference number 125, the query device may transmit, for the user device, a first indication that indicates the multiple database queries. The first indication may indicate the multiple database queries themselves and/or may indicate metadata relating to the multiple database queries, such as tags associated with the database queries, information indicating one or more database tables used by the database queries, natural-language summaries of the database queries, and/or natural-language summaries of the data that the database queries are configured to retrieve. As shown by reference number 130, the query device may receive, from the user device, a second indication that indicates a selection of a database query from the multiple database queries. The second indication may indicate that the selected database query is selected for execution.

As shown in FIG. 1E, and by reference number 135, the query device may analyze the database query (e.g., a single database query identified in a search result, a single database query that is generated, or a single database query that is selected by the query device or the user from multiple database queries) to identify data access information relating to data associated with execution of the database query (e.g., data that is accessed by the database query). For example, the query device may parse the database query to extract the data access information. The data access information may indicate one or more databases, one or more database tables, and/or one or more data fields, among other examples, that would be accessed by the database query. Additionally, or alternatively, the data access information may indicate a classification of the data associated with execution of the database query (e.g., account settings information, salary information, or the like). Thus, the data access information may be indicative of the data associated with execution of the database query. To extract the data access information from the database query, the query device may compare the database query against a database schema or may process the database query using natural language processing, among other examples.

As shown by reference number 140, the query device may determine whether the set of data access permissions permits the user to access the data associated with execution of the database query (e.g., data that would be retrieved by the database query). For example, the query device may determine whether the set of data access permissions permits the user to access the data based on the data access information. In some implementations, the query device may determine whether the set of data access permissions permits the user to access the data using metadata relating to the database(s), database table(s), and/or data field(s) indicated by the data access information. For example, the metadata may indicate a security level, authorized organizational roles, authorized individuals, or the like, associated with a database, a database table, and/or a data field. By confirming that the set of data access permissions permits the user to access the data, the security of the data is tightly controlled.

As shown in FIG. 1F, and by reference number 145, the query device may cause execution of the database query. For example, the query device may cause execution of the database query provided that the set of data access permissions permits the user to access the data associated with execution of the database query (e.g., the data that would be retrieved by the database query). As an example, the query device may cause execution of the database query based on the set of data access permissions permitting the user to access the data. In this way, database queries that retrieve data that should not be accessed by the user are not executed, thereby conserving computing resources that would otherwise be used executing those database queries.

As shown by reference number 150, in some implementations, to cause execution of the database query, the query device may transmit (e.g., based on the set of data access permissions permitting the user to access the data) the database query to the data system to cause execution of the database query by the data system. For example, the query device may generate an API request that indicates the database query, and may transmit the API request via an API endpoint (e.g., a uniform resource locator (URL)) for the data system. By selectively transmitting the database query to the data system only if the set of data access permissions permits the user to access the data, the query device conserves network resources that would otherwise be used transmitting database queries without such selectivity.

In some implementations, the query device may transmit, to the data system, the database query and the information indicating the set of data access permissions (e.g., the set of data access permissions itself or the information about the user that implies the set of data access permissions, as described herein) to enable the data system to determine whether the set of data access permissions permits the user to access the data. Accordingly, the data system may refrain from executing the database query if the set of data access permissions does not permit the user to access the data. In some implementations, the query device may transmit the database query and/or the information indicating the set of data access permissions to multiple data systems (e.g., to a first data system and to a second data system). For example, the database query may use multiple data sources (e.g., a first database of a first data system and a second database of a second data system).

As shown by reference number 155, the query device may receive, from the data system (e.g., from one or more data systems), the data associated with execution of the database query (e.g., the data retrieved by execution of the database query). For example, the query device may receive an API response, via the API endpoint, that indicates the data. As shown by reference number 160, the query device may transmit the data for the user device. In some implementations, the query device may transmit both the data and the database query for the user device. In some implementations, the query device may generate a data file that indicates the data, and to transmit the data for the user device, the query device may transmit the data file for the user device. Alternatively, the query device may transmit, for the user device, instructions for accessing and downloading the data file. The data file may be a comma-separated values (CSV) file, an eXtensible Markup Language (XML) file, a JavaScript Object Notation (JSON) file, or the like.

Techniques described herein enable the identification/generation of a database query that is optimized with an efficient execution plan. Accordingly, execution of the database query may conserve computing resources relative to database queries that lack optimization. Moreover, techniques described herein verify that the user has access to the data before causing execution of the database query. In this way, data security is maintained at a high level, and computing resources are expended only for legitimate database queries.

As indicated above, FIGS. 1A-1F are provided as an example. Other examples may differ from what is described with regard to FIGS. 1A-1F.

FIG. 2 is a diagram of an example environment 200 in which systems and/or methods described herein may be implemented. As shown in FIG. 2, environment 200 may include a query device 210, a user device 220, a data system 230, and a network 240. Devices of environment 200 may interconnect via wired connections, wireless connections, or a combination of wired and wireless connections.

The query device 210 may include one or more devices capable of receiving, generating, storing, processing, providing, and/or routing information associated with executing a database query responsive to a search query, as described elsewhere herein. The query device 210 may include a communication device and/or a computing device. For example, the query device 210 may include a server, such as an application server, a client server, a web server, a database server, a host server, a proxy server, a virtual server (e.g., executing on computing hardware), or a server in a cloud computing system. In some implementations, the query device 210 may include computing hardware used in a cloud computing environment.

The user device 220 may include one or more devices capable of receiving, generating, storing, processing, and/or providing information associated with executing a database query responsive to a search query, as described elsewhere herein. The user device 220 may include a communication device and/or a computing device. For example, the user device 220 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The data system 230 may include one or more devices capable of receiving, generating, storing, processing, providing, and/or routing information associated with executing a database query responsive to a search query, as described elsewhere herein. The data system 230 may include a communication device and/or a computing device. For example, the data system 230 may include a server, such as an application server, a client server, a web server, a database server, a host server, a proxy server, a virtual server (e.g., executing on computing hardware), or a server in a cloud computing system. In some implementations, the data system 230 may include computing hardware used in a cloud computing environment.

The data system 230 may include computing hardware, a resource management component, a host operating system (OS), and/or one or more virtual computing systems. The data system 230 may execute on, for example, a Snowflake platform. The resource management component may perform virtualization (e.g., abstraction) of computing hardware to create the one or more virtual computing systems. The computing hardware may include hardware and corresponding resources from one or more computing devices. In some implementations, the resource management component executes within and/or in coordination with the host OS. The data system 230 may include a virtual environment that enables cloud-based execution of operations and/or processes described herein using the computing hardware.

The network 240 may include one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with executing a database query responsive to a search query. The device 300 may correspond to query device 210, user device 220, and/or data system 230. In some implementations, query device 210, user device 220, and/or data system 230 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

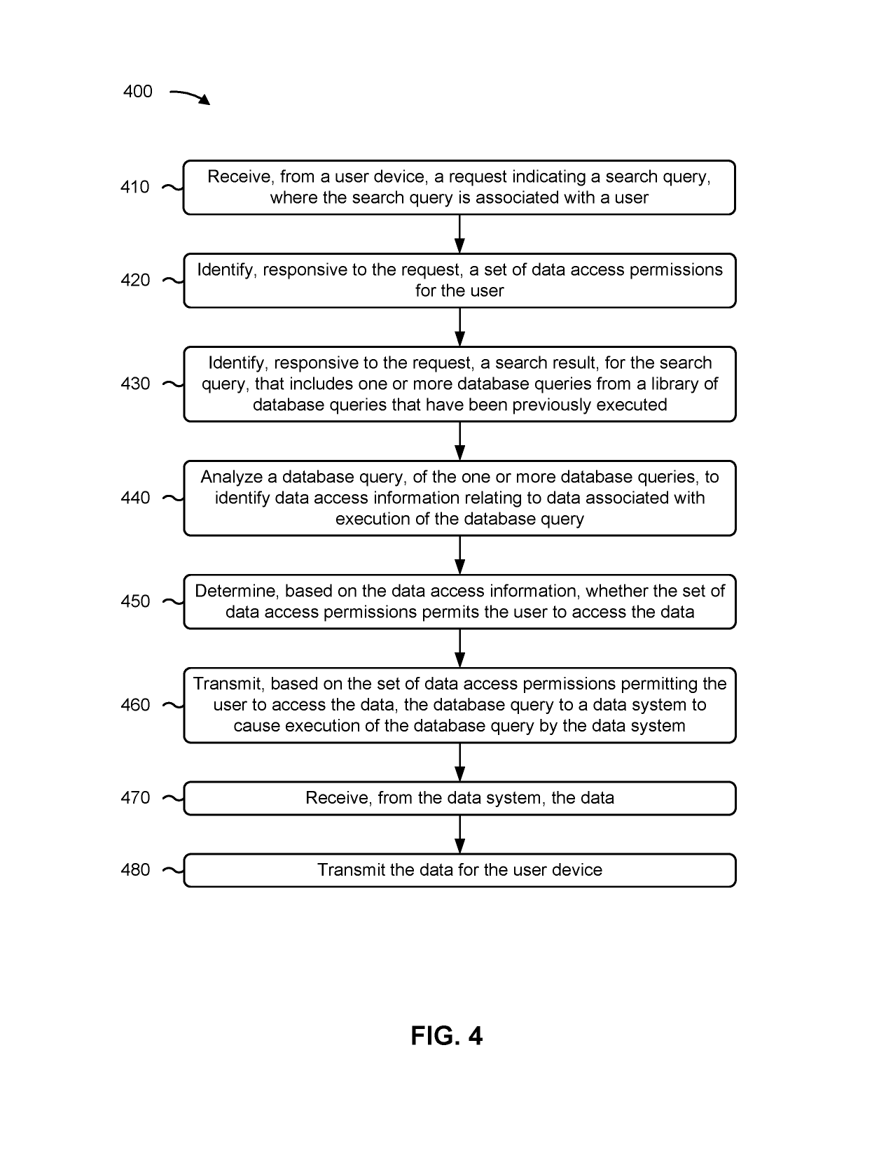

FIG. 4 is a flowchart of an example process 400 associated with executing a database query responsive to a search query. In some implementations, one or more process blocks of FIG. 4 may be performed by the query device 210. In some implementations, one or more process blocks of FIG. 4 may be performed by another device or a group of devices separate from or including the query device 210, such as the user device 220 and/or the data system 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, from a user device, a request indicating a search query, where the search query is associated with a user (block 410). For example, the query device 210 (e.g., using processor 320, memory 330, and/or communication component 360) may receive, from a user device, a request indicating a search query, where the search query is associated with a user, as described above in connection with reference number 105 of FIG. 1A. As an example, the user may have provided the user input indicating the search query, the search query may relate to data of interest to the user, or the like.

As further shown in FIG. 4, process 400 may include identifying, responsive to the request, a set of data access permissions for the user (block 420). For example, the query device 210 (e.g., using processor 320 and/or memory 330) may identify, responsive to the request, a set of data access permissions for the user, as described above in connection with reference number 115 of FIG. 1B. As an example, the set of data access permissions may indicate one or more data sources and/or one or more data types that the user is permitted to access.

As further shown in FIG. 4, process 400 may include identifying, responsive to the request, a search result, for the search query, that includes one or more database queries from a library of database queries that have been previously executed (block 430). For example, the query device 210 (e.g., using processor 320 and/or memory 330) may identify, responsive to the request, a search result, for the search query, that includes one or more database queries from a library of database queries that have been previously executed, as described above in connection with reference number 120a of FIG. 1C. As an example, the search result may be identified by searching the library using the search query.

As further shown in FIG. 4, process 400 may include analyzing a database query, of the one or more database queries, to identify data access information relating to data associated with execution of the database query (block 440). For example, the query device 210 (e.g., using processor 320 and/or memory 330) may analyze a database query, of the one or more database queries, to identify data access information relating to data associated with execution of the database query, as described above in connection with reference number 135 of FIG. 1E. As an example, the data access information may indicate one or more databases, one or more database tables, and/or one or more data fields, among other examples, that would be accessed by the database query.

As further shown in FIG. 4, process 400 may include determining, based on the data access information, whether the set of data access permissions permits the user to access the data (block 450). For example, the query device 210 (e.g., using processor 320 and/or memory 330) may determine, based on the data access information, whether the set of data access permissions permits the user to access the data, as described above in connection with reference number 140 of FIG. 1E. As an example, a determination of whether the set of data access permissions permits the user to access the data may use metadata relating to the database(s), database table(s), and/or data field(s) indicated by the data access information. For example, the metadata may indicate a security level, authorized organizational roles, authorized individuals, or the like, associated with a database, a database table, and/or a data field.

As further shown in FIG. 4, process 400 may include transmitting, based on the set of data access permissions permitting the user to access the data, the database query to a data system to cause execution of the database query by the data system (block 460). For example, the query device 210 (e.g., using processor 320, memory 330, and/or communication component 360) may transmit, based on the set of data access permissions permitting the user to access the data, the database query to a data system to cause execution of the database query by the data system, as described above in connection with reference number 150 of FIG. 1F. As an example, an API request that indicates the database query may be transmitted via an API endpoint for the data system.

As further shown in FIG. 4, process 400 may include receiving, from the data system, the data (block 470). For example, the query device 210 (e.g., using processor 320, memory 330, and/or communication component 360) may receive, from the data system, the data, as described above in connection with reference number 155 of FIG. 1F. As an example, an API response that indicates the data may be received via the API endpoint.

As further shown in FIG. 4, process 400 may include transmitting the data for the user device (block 480). For example, the query device 210 (e.g., using processor 320, memory 330, and/or communication component 360) may transmit the data for the user device, as described above in connection with reference number 160 of FIG. 1F. As an example, both the data and the database query may be transmitted for the user device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1F. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code - it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for executing a database query responsive to a search query, the system comprising:
one or more memories; and
one or more processors, communicatively coupled to the one or more memories, configured to:
receive, from a user device, a request indicating a search query,
wherein the search query is associated with a user;
identify, responsive to the request, a set of data access permissions for the user;
identify, responsive to the request, a search result, for the search query, that includes a database query from a library of database queries that have been previously executed;
parse the database query to extract, from the database query, data access information that indicates at least one of: one or more databases, one or more database tables, or one or more data fields in the database query;
determine, based on the data access information, whether the set of data access permissions permits the user to access data associated with execution of the database query;
transmit, based on the set of data access permissions permitting the user to access the data, the database query to a data system to cause execution of the database query by the data system;
receive, from the data system, the data; and
transmit the data for the user device.

2. The system of claim 1, wherein the data system includes a cloud-based data warehouse.

3. The system of claim 1, wherein the one or more processors, to transmit the data, are configured to:
generate a data file that indicates the data; and
transmit the data file for the user device.

4. The system of claim 1, wherein the one or more processors, to determine whether the set of data access permissions permits the user to access the data, are configured to:
determine whether the set of data access permissions permits the user to access the data using metadata relating to the data access information.

5. The system of claim 1, wherein the one or more processors, to transmit the database query to the data system, are configured to:
generate an application programming interface (API) request that indicates the database query; and
transmit the API request via an API endpoint for the data system.

6. The system of claim 1, wherein the one or more processors are further configured to:
modify the database query in accordance with the search query.

7. The system of claim 1, wherein the library of database queries only includes database queries having execution properties that satisfy one or more conditions relating to execution time, processor usage, memory usage, or disk input/output operations.

8. A method of executing a database query responsive to a search query, comprising:
receiving, from a user device, a request indicating a search query,
wherein the search query is associated with a user;
identifying, responsive to the request, a set of data access permissions for the user;
identifying, responsive to the request, a search result, for the search query, that includes one or more database queries from a library of database queries that have been previously executed; analyzing a database query, of the one or more database queries, to identify data access information relating to data associated with execution of the database query; determining, based on the data access information, whether the set of data access permissions permits the user to access the data; transmitting, based on the set of data access permissions permitting the user to access the data, the database query to a data system to cause execution of the database query by the data system;
receiving, from the data system, the data; and
transmitting the data for the user device.

9. The method of claim 8, further comprising:
transmitting, for the user device, a first indication that indicates the one or more database queries; and
receiving, from the user device, a second indication that indicates a selection of the database query, from the one or more database queries, for execution.

10. The method of claim 8, wherein the data and the database query are transmitted for the user device.

11. The method of claim 8, wherein determining whether the set of data access permissions permits the user to access the data comprises:
determining whether the set of data access permissions permits the user to access the data using metadata relating to the data access information.

12. The method of claim 8, wherein the data access information indicates a classification of the data.

13. The method of claim 8, wherein the set of data access permissions indicates at least one of:
one or more databases that the user is permitted to access,
one or more database tables that the user is permitted to access,
one or more data fields that the user is permitted to access, or
one or more data categories that the user is permitted to access.

14. The method of claim 8, wherein the library of database queries only includes database queries having execution properties that satisfy one or more conditions relating to execution time, processor usage, memory usage, or disk input/output operations.

15. A non-transitory computer-readable medium storing a set of instructions for executing a database query responsive to a search query, the set of instructions comprising:
one or more instructions that, when executed by one or more processors of a device, cause the device to:
receive, from a user device, a request indicating a search query,
wherein the search query is associated with a user;
identify, responsive to the request, information indicating a set of data access permissions for the user;
identify, responsive to the request and the search query, a database query;
cause, provided that the set of data access permissions permits the user to access data associated with execution of the database query, execution of the database query; and
transmit the data for the user device.

16. The non-transitory computer-readable medium of claim 15, wherein the one or more instructions, that cause the device to cause execution of the database query, cause the device to:
transmit the database query to a data system to cause execution of the database query by the data system.

17. The non-transitory computer-readable medium of claim 16, wherein the one or more instructions, that cause the device to transmit the database query to the data system, cause the device to:
transmit the database query and the information indicating the set of access permissions to the data system to enable the data system to determine whether the set of data access permissions permits the user to access the data.

18. The non-transitory computer-readable medium of claim 15, wherein the one or more instructions, that cause the device to identify the database query, cause the device to:
generate the database query using the search query as an input to a machine learning model.

19. The non-transitory computer-readable medium of claim 15, wherein the one or more instructions, that cause the device to identify the database query, cause the device to:
identify the database query from a library of database queries that have been previously executed.

20. The non-transitory computer-readable medium of claim 15, wherein the one or more instructions, when executed by the one or more processors, further cause the device to:
parse the database query to extract, from the database query, data access information that indicates at least one of: one or more databases, one or more database tables, or one or more data fields in the database query; and
determine, based on the data access information, whether the set of data access permissions permits the user to access data associated with execution of the database query.
